(19) United States
(12) Patent Application Publication
(10) Pub. No.: US 2025/0093570 A1
(43) Pub. Date: Mar. 20, 2025

(54) BACKLIT CIRCUIT BOARD, BACKLIT KEYSWITCH AND KEYBOARD

(71) Applicant: Darfon Electronics Corp., Taoyuan City (TW)

(72) Inventors: Yi-Jui PAN, Taoyuan City (TW); Po-Yueh CHOU, Taoyuan City (TW)

(21) Appl. No.: 18/890,846

(22) Filed: Sep. 20, 2024

Related U.S. Application Data
(60) Provisional application No. 63/583,875, filed on Sep. 20, 2023.

(30) Foreign Application Priority Data
Sep. 18, 2024 (TW) 113210135

(51) Int. Cl. F21V 8/00; H01H 13/02; H01H 13/702

(52) U.S. Cl. CPC G02B 6/0055; G02B 6/0021; H01H 13/023; H01H 13/702

(57) ABSTRACT

A backlit circuit board for supporting a keycap is provided. The backlit circuit board includes a substrate having a plurality of ribs configured to define a plurality of openings penetrating through the substrate and a plurality of coupling members disposed on the substrate and configured to directly or indirectly connect the keycap, a lighting circuit disposed on the substrate at a same side as the coupling members and extending over the plurality of ribs, and an illuminant electrically connected to the lighting circuit and disposed on one of the plurality of ribs, wherein the illuminant vertically corresponds to a light impermeable region of the keycap, and a vertical projection of the light impermeable region at least partially overlaps the plurality of ribs.

### CROSS-REFERENCE TO RELATED APPLICATION

This application claims the priority benefits of Taiwan patent application serial No. 113210135, filed on Sep. 18, 2024, and also claims the priority benefits of U.S. provisional application Ser. No. 63/583,875, filed Sep. 20, 2023. The entirety of the mentioned above patent applications is hereby incorporated by reference herein and made a part of this specification.

### BACKGROUND OF THE INVENTION

### 1. Field of the Invention

The invention generally relates to a backlit circuit board. Particularly, the invention relates to a backlit circuit board having keyswitch coupling members, and a backlit keyswitch and keyboard having the backlit circuit board.

### 2. Description of the Prior Art

Conventional backlit keyswitches and keyboards are usually manufactured by separately forming the keyswitch structure that generates a trigger signal and the backlit module that provides backlight, and then combining the keyswitch structure and the backlit module together. However, the conventional keyswitch structure and backlight module are multi-layer stacked structures, respectively, so that the reduction in the overall thickness of the backlit keyswitch (or keyboard) is not easy, which is not conducive to the thinning of the device.

### SUMMARY OF THE INVENTION

It is an object of the invention to provide a backlit circuit board, which can serve as not only the baseplate for the keyswitch structure, but also the light source circuit board.

It is another object of the invention to provide a backlit circuit board, which integrates the lighting circuit with the baseplate of the keyswitch structure to effectively reduce the overall thickness of the backlit keyswitch.

In an embodiment, the invention provides a backlit circuit board for supporting a keycap. The backlit circuit board includes a substrate having a plurality of ribs configured to define a plurality of openings penetrating through the substrate and a plurality of coupling members disposed on the substrate and configured to directly or indirectly connect the keycap, a lighting circuit disposed on the substrate at a same side as the plurality of coupling members, the lighting circuit extending over the plurality of ribs of the substrate, and an illuminant electrically connected to the lighting circuit and disposed on one of the plurality of ribs of the substrate, wherein the illuminant vertically corresponds to a light impermeable region of the keycap, and a vertical projection of the light impermeable region at least partially overlaps the plurality of ribs of the substrate.

In an embodiment, the substrate is a non-metal plate, so that an upper surface of the substrate is an insulation surface.

In an embodiment, the substrate includes a metal plate and an insulation layer at least partially covering an upper surface of the metal plate.

In an embodiment, the backlit circuit board further includes a switch circuit layer, wherein the switch circuit layer and the lighting circuit are disposed at a same side of the substrate; the switch circuit layer has a switch unit; a vertical projection of the switch unit does not overlap the illuminant.

In an embodiment, the switch circuit layer has a first hole corresponding to the illuminant.

In an embodiment, the switch circuit layer has a second hole corresponding to one of the plurality of coupling members.

In an embodiment, the switch circuit layer has a switch circuit electrically connected to the switch unit; vertical projections of the switch circuit and the lighting circuit at least partially overlaps one of the plurality of ribs of the substrate.

In an embodiment, the vertical projection of the switch unit and a vertical projection of the illuminant fall within a range surrounded by the plurality of coupling members.

In an embodiment, the backlit circuit board further includes a light-absorption layer disposed on the switch circuit layer to define at least one light permeable window corresponding to the keycap.

In an embodiment, the backlit circuit board further includes a protective layer disposed on the substrate to cover the lighting circuit; the protective layer has a reflective surface and/or a microstructure located within a vertical projection of the at least one light permeable window.

In an embodiment, the protective layer has a reflective surface and/or a microstructure, and the microstructure overlaps at least one of the plurality of ribs.

In an embodiment, the plurality of coupling members extend from the substrate above the lighting circuit.

In another embodiment, the invention provides a backlit keyswitch including the above backlit circuit board and the keycap.

In a further embodiment, the invention provides a backlit keyboard including the above backlit circuit board and the keycap.

In yet another embodiment, the invention provides a backlit keyswitch including a keycap, a circuit board having a lighting circuit, an illuminant, and a plurality of coupling members configured to directly or indirectly connect the keycap, the lighting circuit disposed on an upper surface of the circuit board and electrically connected to the illuminant, a membrane switch circuit board disposed between the keycap and the circuit board, the membrane switch circuit board having a film hole for accommodating the illuminant, and a glue layer disposed around the film hole and configured to adhere the circuit board and the membrane switch circuit board, wherein a glue-free region is formed between the glue layer and the film hole.

In an embodiment, the keycap has a light permeable region and a light impermeable region; the illuminant is at least partially located outside of a vertical projection of the light permeable region.

In an embodiment, the backlit keyswitch further includes a reflective layer at least partially covering the illuminant.

In an embodiment, the backlit keyswitch further includes a light-absorption layer disposed on the membrane switch circuit board to define at least one light-permeable window corresponding to the keycap.

In an embodiment, the circuit board further has a protective layer configured to cover the lighting circuit; the protective layer has a reflective surface and/or a microstructure located within a vertical projection of the at least one light permeable window.

In an embodiment, the membrane switch circuit board is a multi-layered structure; the film hole is a through hole penetrating through the multi-layered structure or a blind hole formed though at least one layer of the multi-layered structure.

In an embodiment, the membrane switch circuit board has a microstructure; when the film hole is the blind hole formed though the at least one layer of the multi-layered structure, the microstructure is disposed on the at least one layer of the multi-layered structure.

In an embodiment, the glue layer is an open-ring shaped glue layer with a breach.

Compared with the prior art, the backlit circuit board of the invention can function as the baseplate of the keyswitch structure and further has the lighting circuit to function as the light source circuit board at the same time. Moreover, the backlit circuit board of the invention integrates the lighting circuit with the baseplate of the keyswitch structure, so that the overall thickness of keyswitch can be effectively reduced to facilitate the thinning design. The backlit keyswitch of the invention accommodates the illuminant in the film hole of the membrane switch circuit board, so that with the light guiding effect of the membrane switch circuit board, additional light guide plate can be omitted to further facilitate the thinning design.

### BRIEF DESCRIPTION OF THE DRAWINGS

FIG. 1 is a schematic view of the backlit keyboard in an embodiment of the invention.

FIG. 2 is a schematic cross-sectional view of the backlit keyswitch in an embodiment of the invention.

FIG. 3 is a schematic top view of the backlit circuit board in an embodiment of the invention.

FIG. 4 is a schematic top view showing the upper surface of the backlit circuit board around the illuminant in an embodiment of the invention.

FIG. 5 is a schematic cross-sectional view of the backlit keyswitch in another embodiment of the invention.

FIG. 6 is a schematic top view showing the upper surface of the backlit circuit board around the illuminant in another embodiment of the invention.

### DETAILED DESCRIPTION OF THE PREFERRED EMBODIMENT

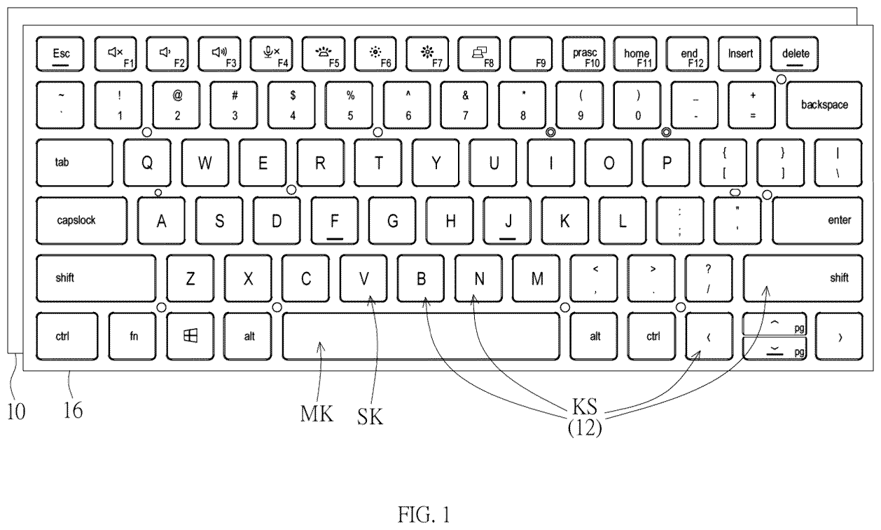

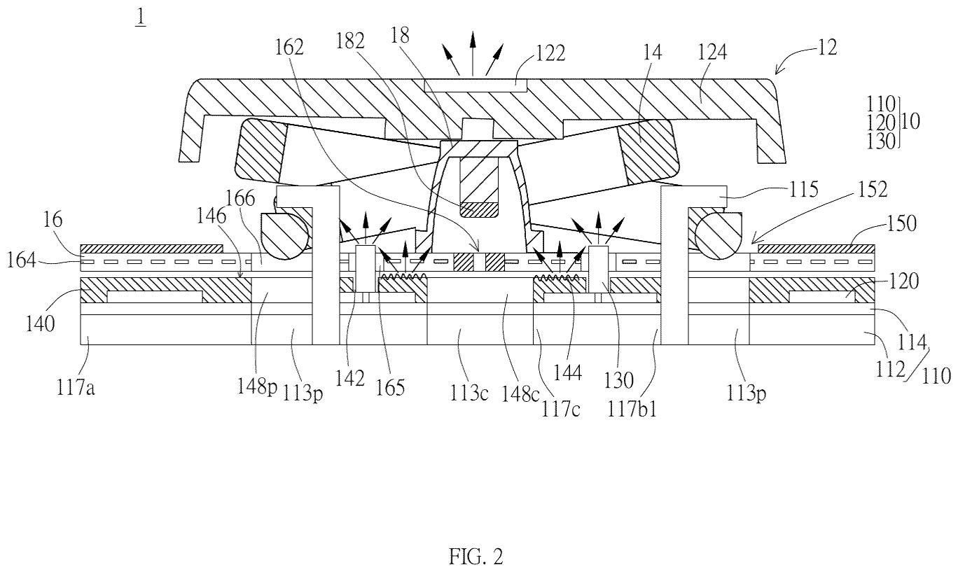

The invention mainly involves the integration of the baseplate of the keyswitch and the lighting circuit to achieve the reduction in the overall thickness of keyswitch and to promote the luminous effect and the luminance uniformity for a single keyswitch or even the entire keyboard. Referring to FIG. 1 and FIG. 2, FIG. 1 is a schematic view of the backlit keyboard KB in an embodiment of the invention, and FIG. 2 is a schematic cross-sectional view of the backlit keyswitch 1 in an embodiment of the invention. In an embodiment, the backlit keyboard KB of the invention includes a plurality of keyswitches KS (such as square keyswitches SK or multiple keyswitches MK). Each keyswitch KS (e.g. the backlit keyswitch 1 in FIG. 2) includes a keycap 12, an up-down lift structure 14, a switch circuit layer 16, a restoring member 18, and a backlit circuit board 10. For the backlit keyboard KB, the backlit circuit board 10 includes a lighting circuit 120 and an illuminant 130, so that the backlit circuit board 10 can function as the baseplate of the keyswitch KS and the light source circuit board which is configured to provide the backlight.

As shown in FIG. 2, the keycap 12 is disposed over the backlit circuit board 10 and has a light permeable region 122 (e.g. one or more light permeable characters) and a light impermeable region 124. The up-down lift structure 14 is connected between the backlit circuit board 10 and the keycap 12 and configured to support the up-down movement of the keycap 12 relative to the backlit circuit board 10. The switch circuit layer 16 is disposed under the keycap 12 and preferably on the backlit circuit board 10. The switch circuit layer 16 has a switch unit 162 and a switch circuit 164 electrically connected to the switch unit 162. When the keycap 12 is pressed, the switch unit 162 of the switch circuit layer 16 will be conducted to trigger the keyswitch signal. The restoring member 18 is disposed between the keycap 12 and the backlit circuit board 10 and configured to provide a restoring force to enable the keycap 12 to move upward relative to the backlit circuit board 10 to the non-pressed position when the pressing force is released. In this embodiment, the restoring member 18 can be embodied as an elastic member (e.g. rubber dome) and disposed corresponding to the switch unit 162. When the keycap 12 is pressed and moves downward to compress the restoring member 18, the triggering portion 182 of the restoring member 18 can trigger the switch unit 162, but not limited thereto, The switch unit 162 can be triggered by a triggering portion, which can be disposed on the restoring member 18, the up-down lift structure 14, or the keycap 12. According to practical applications, the restoring member 18 can be embodied as any suitable element, which can provide the restoring force to enable the keycap 12 to return the non-pressed position, such as spring, magnetic member. The switch of the backlit keyswitch 1 is not limited to the switch unit 162 of the switch circuit layer 16 and can be any suitable switch, which is triggered in response to the downward movement of the keycap 12, such as mechanical switch, magnetic switch, optical switch. In this embodiment, the up-down lift structure 14 can be embodied as a scissors-like up-down lift structure, which has two frames pivotally coupled with each other, and two ends of each frame are movably coupled to the backlit circuit board 10 and the keycap 12, respectively, but not limited thereto. According to practical applications, the up-down lift structure 14 can be embodied as a butterfly up-down lift structure, a cantilever up-down lift structure, etc. The backlit circuit board 10, the keycap 12, the up-down lift structure 14, the switch circuit layer 16, and the restoring member 18 can constitute the backlit keyswitch 1. Hereinafter, the backlit circuit board 10 of the invention will be described in detail.

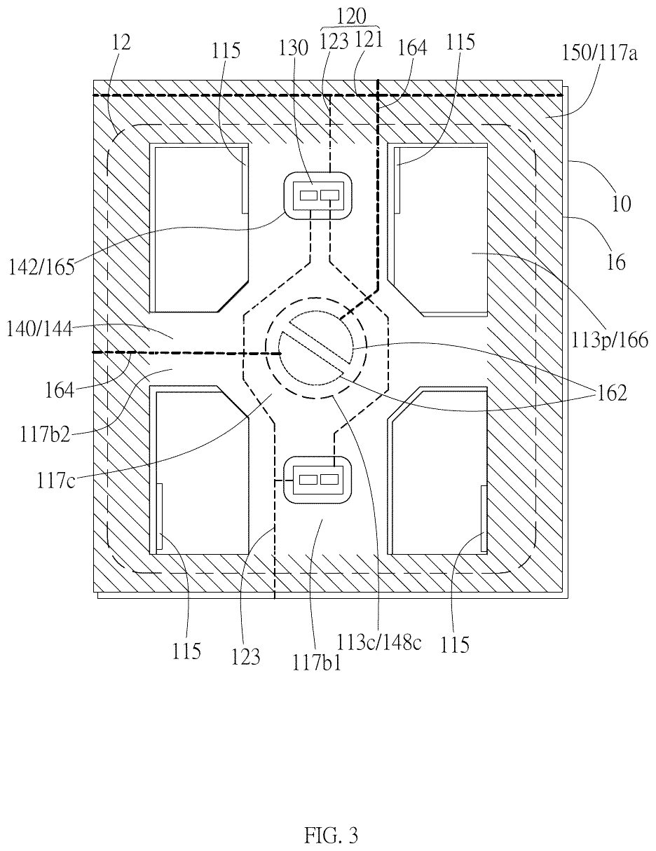

Referring to FIG. 2 and FIG. 3, FIG. 3 is a schematic top view of the backlit circuit board in an embodiment of the invention. The backlit circuit board 10 is configured to support at least one keycap, such as keycap 12. The backlit circuit board 10 can include a substrate 110, a lighting circuit 120, and an illuminant 130. The substrate 110 has a plurality of ribs, such as 117a, 117b1, 117b2, 117c, and a plurality of coupling members 115. The plurality of ribs are configured to define a plurality of openings, such as 113c, 113p. The plurality of openings penetrate through the substrate 110. For example, the substrate 110 has a plurality of ribs, such as a frame rib 117a, a first bridge rib 117b1, a second bridge rib 117b2, and a central island rib 117c, which are configured to define, for example, one central opening 113c and a plurality of peripheral openings 113p, such as four peripheral openings. For example, the frame rib 117a is disposed corresponding to the periphery of the keycap 12 to have a frame shape and functions as a connection part with adjacent keyswitches. The central island rib 117c is disposed corresponding to the center or in the neighborhood of the center of the keycap 12 and surrounded by the frame rib 117a. The first bridge rib 117b1 and the second bridge rib 117b2 are configured to connect the frame rib 117a and the central island rib 117c along different directions (e.g. vertical and horizontal directions), respectively. For example, four peripheral openings 113p are formed between the frame rib 117a and the bridge ribs, such as the first bridge rib 117b1 and the second bridge rib 117b2. From another aspect, the first bridge rib 117b1 and the second bridge rib 117b2 act as connections ribs, which extend in radial directions from the central island rib 117c to the frame rib 117a and are configured to connect the frame rib 117a and the central island rib 117c. In this embodiment, the central island rib 117c can be configured as a ring-shaped island, so that the central island rib 117c can define the central opening 113c in the center of ring, but not limited thereto. According to practical applications, the central island rib 117c can be a solid island, so that the substrate 110 may not have the central opening 13c. It is noted that the shape, amount, location of the ribs and the openings can be determined according to the structural strength of the backlit keyswitch 1, the location of the light permeable region 122 of the keycap 12, the power of the illuminant 130, etc. The plurality of coupling members 115 are disposed on the substrate 110 and configured to directly or indirectly connect the at least one keycap 12. In this embodiment, the coupling member 115 can be a hook-shaped coupler, and the keycap 12 is coupled to the backlit circuit board 10 by coupling the up-down lift structure 14 with the coupling members 115, but not limited thereto. According to practical applications, the coupling member 115 can be in the form of a groove, a post, etc.

In an embodiment, the substrate 110 can include a metal plate 112 and an insulation layer 114. The insulation layer 114 at least partially covers the upper surface of the metal plate 112, so that the upper surface of the substrate 110 can be an insulation surface (i.e., the upper surface of the insulation layer 114). The metal plate 112 can be a conductive plate, such as an aluminum alloy plate or a steel plate, so that the metal plate 112 itself can shield radio waves and functions as a grounding component to reduce the electrostatic discharge (ESD) problem. The insulation layer 114 can be formed by any suitable methods, such as adhering, printing, coating, disposition, molding, to cover the upper surface of the metal plate 112, so that the upper surface of the substrate 110 is the insulation surface. For example, the insulation layer 114 can be disposed on the entire upper surface of the metal plate 112 or a partial upper surface of the metal plate 112 where the lighting circuit 120 is to be arranged. In an embodiment (not shown), the insulation layer 114 can further cover the inner wall (sidewall) of the opening (113c, 113p) or other through holes, the sidewall of the metal plate 112, the surface of the coupling member 115, and/or the lower surface of the metal plate 112 to prevent the ESD problem caused by the exposure of metal plate 112. Moreover, the insulation layer 114 can include any suitable insulative material, such as polymers, dielectrics, which can electrically isolate the metal plate 112 from conductive wirings (e.g. the lighting circuit 120). When the substrate 110 adopts the metal plate 112, the coupling members 115 can be formed by the following methods, for example: (1) stamping the metal plate to form flat coupling members, and then bending the coupling members to stand on the metal plate, (2) using the insert-molding technique to form plastic coupling members on the metal plate, or (3) using the hot-melting technique to fix preformed plastic coupling members on the metal plate, but not limited thereto. In another embodiment, the substrate 110 can be a non-metal plate, such as a non-conductive plate made of glass fiber, carbon fiber, artificial resin, or polymers, so that the upper surface of the substrate 110 is the insulation surface (e.g. the upper surface of the non-metal plate). When the substrate 110 adopts the non-metal plate, the coupling members 115 can be formed by the following methods, for example: (1) using the mold injection technique to form the substrate 110 with the coupling members 115 at one time, (2) using the insert-molding technique to form plastic coupling members on the non-metal plate, (3) using the hot-melting technique to fix preformed plastic coupling members on the non-metal plate, (4) fixing a metal frame with the coupling members 115 on the non-metal plate, or (5) fixing a metal frame on the non-metal plate, and then using the hot-melting technique to fix preformed plastic coupling members on the metal frame, but not limited thereto.

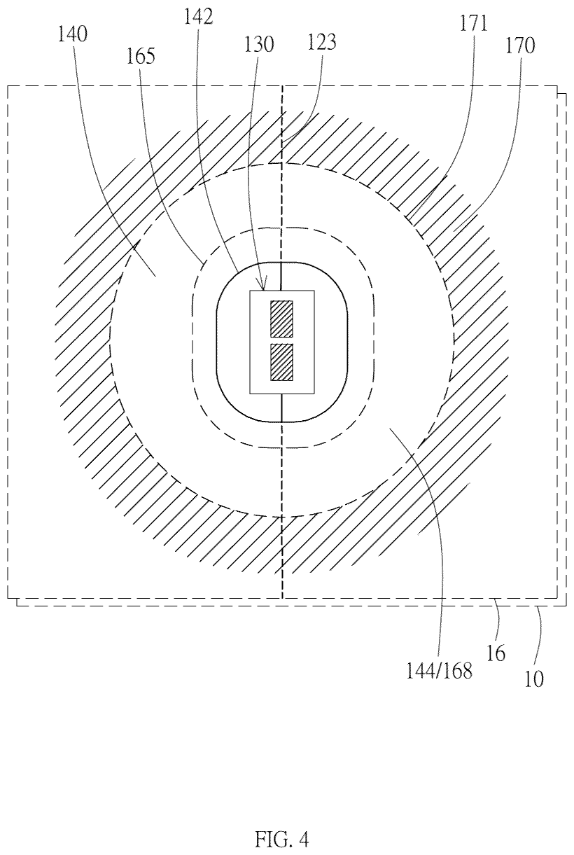

Referring to FIG. 2, FIG. 3, and FIG. 4, FIG. 4 is a schematic top view showing the upper surface of the backlit circuit board around the illuminant in an embodiment of the invention. As shown in FIG. 2 to FG. 4, the lighting circuit 120 is disposed on the substrate 110 and located at a same as the plurality of coupling members 115. The lighting circuit 120 preferably extends over the plurality of ribs (e.g. 117a, 117b1, 117b2, 117c) of the substrate 110. Specifically, the coupling members 115 and the lighting circuit 120 are located on the upper surface of the substrate 110, and the plurality of coupling members 115 preferably extend from the substrate 110 above the lighting circuit 120. The lighting circuit 120 can be formed on the upper surface of the substrate 110 by printing metal paste (e.g. silver paste) or etching a metal foil (e.g. copper foil) to form a metal foil circuit. The lighting circuit 120 can include one or more main wirings 121 and one or more sub-wirings 123, which are configured to electrically connect the illuminant 130 with a driving component (not shown), so that the illuminant 130 can be driven to emit light. From another aspect, the lighting circuit 120 is preferably formed at least one of the plurality of ribs of the substrate 110 without covering the openings (e.g. 113c, 113p) of the substrate 110, so that the lighting circuit 120 can be considered as a circuit layer having holes corresponding to the openings (e.g. 113p) of the substrate 110. The plurality of coupling members 115 are disposed in pair corresponding to the peripheral openings 113p and extend through the holes of the lighting circuit 120 which correspond to the peripheral openings 113p to be above the lighting circuit 120.

The illuminant 130 is electrically connected to the lighting circuit 120 and configured to receive the power through the lighting circuit 120 for driving the illuminant 130 to emit light. For example, the illuminant 130 can be mounted on the lighting circuit 120 through a conductive adhesive to electrically connect the lighting circuit 120, but not limited thereto. In another embodiment, the illuminant 130 can be fixed on the upper surface of the substrate 110 through a non-conductive adhesive and then electrically connected to the lighting circuit 120 through other conductive wirings. The illuminant 130 can be embodied as a light-emitting diode (LED) of a single chip or multiple chips. In an embodiment, the illuminant 130 can be a min LED or micro LED, which has low luminance and low power and majorly emits light from the top surface. The backlit keyswitch 1 can have one or more illuminants 130, and the illuminant 130 is preferably disposed on one of the ribs of the substrate 110. For example, in this embodiment, two illuminants 130 are disposed on the first bridge 117b1 and located at two opposite sides of the central island rib 117c, respectively. Mover, in order to avoid excessive luminance right above the illuminant 130, the illuminant 130 preferably does not overlap the vertical projection of the light permeable region 122 of the keycap 12, so that the illuminant 130 is at least partially located outside the vertical projection of the light permeable region 122. In other words, the illuminant 130 preferably vertically corresponds to the light impermeable region 124 of the keycap 12, and the vertical projection of the light impermeable region 124 at least partially overlaps the plurality of ribs (e.g. 117a, 117b1, 117b2, 117c) of the substrate 110. In this embodiment, as shown in FIG. 3, two illuminants 130 are disposed on the first bridge rib 117b1 at two sides of the central island rib 117c, so that the first bridge rib 117b1 preferably has a width larger than that of the second bridge rib 117b2. Herein, the “width” refers to the distance between two adjacent peripheral holes 113p arranged at two sides of the extending direction of the bridge rib toward the frame rib. For example, the width of the first bridge rib 117b1 is the distance between left and right peripheral holes 113p at the upper side (or the lower side), and the width of the second bridge rib 117b2 is the distance between upper and lower peripheral holes 113p at the left side (or the right side). In an embodiment, the width of the second bridge rib 117b2 is preferably ⅕ to ½ of the width of the first bridge rib 117b1, but not limited thereto. According to practical applications, the width of the second bridge rib 117b2 can be less than ⅕ of the width of the first bridge rib 117b1 or larger than ½ of the width of the first bridge rib 117b1.

Moreover, the backlit circuit board 10 can optionally include a protective layer 140. The protective layer 140 is disposed on the substrate 110 and covers the lighting circuit 120, thereby providing the lighting circuit 120 with waterproof and insulating effects. In an embodiment, the protective layer 140 preferably has a reflective surface 146 and/or one or more microstructures 144, which are configured to reflect and/or diffuse light, so that the characters on top of the keycap of each keyswitch can have uniform light output, and the halo brightness of each keyswitch can be consistent. In an embodiment, the microstructure 144 overlaps at least one of the plurality of ribs (e.g. 117a, 117b1, 117b2, 117c) of the substrate 110. The protective layer 140 is preferably made of reflective insulation material, so that the upper surface (a surface that is far away from the substrate 110) of the protective layer 140 can serve as the reflective surface 146. In an embodiment, the protective layer 140 can be formed, for example, by printing a white paint or white ink on the upper surface of the substrate 110. The protective layer 140 preferably covers all the upper surface of the substrate 110 and the lighting circuit 120 except where the illuminant 130 is located to have a larger reflective surface 146. From another aspect, the protective layer 140 can be an insulative reflective film with a hole 142 corresponding to the illuminant 130, so that the illuminant 130 can protrude from the hole 142 toward the keycap 12. Moreover, the protective layer 140 may have one or more through holes (such as 148p, 148c) at locations corresponding to the openings (e.g. 113p, 113c) to communicate with the openings of the substrate 110. For example, the protective layer 140 can have peripheral holes 148p corresponding to (or communicating with) the peripheral openings 113p and a central hole 148p corresponding to (or communicating with) the central opening 113c, but not limited thereto. According to practical applications, when the protective layer 140 is formed by a light permeable film, the protective layer 140 may not have such through holes, and the reflective surface 146 of the protective layer 140 can be formed by disposing the reflective material or coating on the upper surface of the protective layer 140. In an embodiment, the microstructure 144 of the protective layer 140 is preferably disposed corresponding to at least one of the ribs (e.g. 117a, 117b1, 117b2, 117c) of the substrate 110, so that in the stacking direction, the microstructure 144 of the protective layer 140 overlaps at least one rib. From another aspect, the microstructure 144 of the protective layer 140 preferably corresponds to the light impermeable region 124 of the keycap 12, so that the microstructure 144 and the light impermeable region 124 of the keycap 12 at least partially overlap with each other in the stacking direction.

In this embodiment, the switch circuit layer 16 and the lighting circuit 120 are disposed at the same side of the substrate 110, such as the upper side. The vertical projections of the switch unit 162 of the switch circuit layer 16 and the illuminant 130 fall within the range surrounded by the plurality of the coupling members 115, and the vertical projection of the switch unit 162 does not overlap the illuminant 130. The switch circuit layer 16 can have an one-layered structure or a multi-layered structure, and the switch unit 162 and the switch circuit 164 are formed on one or more layers thereof. In an embodiment, the switch circuit layer 16 can be implemented as a membrane switch circuit board having a multi-layered structure. The switch unit 162 and the switch circuit 164 can be disposed on one or more layers of the membrane switch circuit board. The switch unit 162 can be triggered by the triggering portion 182 as the keycap 12 moves downward. When the switch circuit layer 16 is implemented as the membrane switch circuit board, the triggering portion 182 can be a conductive type or non-conductive type triggering portion. In another embodiment, the switch circuit layer 16 can be formed by the printing technique or the etching process to form the switch unit 162 and the switch circuit 164 on the upper surface of the protective layer 140, so that the backlit circuit board 10 can further integrate the switch circuit to serve as the baseplate and the switch circuit board of the keyswitch and the light source circuit board at the same time, thereby further effectively reducing the overall thickness of the backlit keyswitch. It is noted that when the switch circuit layer 16 is formed by the printing technique or the etching process to form the switch unit 162 and the switch circuit 164 on the upper surface of the protective layer 140, the triggering portion 182 is preferably a conductive type triggering portion. As such, the conductive type triggering portion 182 can conduct the switch unit 162 in the form of conductive pads by contacting the conductive pads. The switch circuit 164 is preferably disposed over the plurality of ribs (e.g. 117a, 117b1, 117b2, 117c) of the substrate 110, so that the vertical projections of the switch circuit 164 of the switch circuit layer 16 and the lighting circuit 120 at least partially overlap one of the plurality of ribs, such as the first bridge rib 117b1 shown in FIG. 3.

As shown in FIG. 2, the switch circuit layer 16 preferably has a first hole 165, and the first hole 165 corresponds to the illuminant 130. For example, the first hole 165 can be a through hole that penetrates through the switch circuit layer 16, so that the illuminant 130 can be accommodated in the first hole 165 or extend through the first hole 165 to be exposed from the first hole 165. In FIG. 2, the illuminant 130 is illustrated to extend beyond the switch circuit layer 16 to express the concept of the embodiment (for example, the switch circuit layer 16 is a single-layered circuit structure), but not limited thereto. According to practical applications, the height of the illuminant 130 can be equal to or lower than the upper surface of the switch circuit layer 16. For example, when the switch circuit layer 16 is formed on the upper surface of the protective layer 140 by the printing or etching process, the first hole 165 can be a region of the protective layer 140 around the illuminant 130 where the switch circuit 164 is not formed, so the first hole 165 can be regarded as a through hole of the switch circuit layer 16, and the height of the illuminant 130 may exceed the upper surface of the switch circuit layer 16, but not limited thereto. When the switch circuit layer 16 is embodied as a membrane switch circuit board of one-layered or multi-layered structure, the first hole 165 can be a film hole formed in the membrane switch circuit board, and the film hole can be a through hole penetrating through the one-layered or multi-layered structure, wherein the height of the illuminant 130 may be equal to or exceed the upper surface of the switch circuit layer 16, or a blind hole formed though at least one layer of the multi-layered structure, wherein the height of the illuminant 130 is lower than the upper surface of the switch circuit layer 16.

In the embodiment, the switch circuit layer 16 preferably further has one or more second holes 166, and the second hole 166 corresponds to one of the plurality of coupling members 115. For example, the second hole 166 can be a through hole that penetrates through the switch circuit layer 16, and the second hole 166 preferably communicates with the peripheral hole 113p to which the coupling member 115 is located adjacent. The second hole 166 can accommodate the partial descent of the frame of the up-down lift structure 14 to reduce the overall thickness (or height) of keyswitch. For example, when the switch circuit layer 16 is formed on the upper surface of the protective layer 140 by the printing or etching process, the second hole 166 can be a region of the protective layer 140 around the peripheral opening 113p where the switch circuit 164 is not formed, but not limited thereto. When the switch circuit layer 16 is embodied as a membrane switch circuit board of multi-layered structure, the second hole 166 can be a film hole formed in the membrane switch circuit board, and the film hole can be a through hole penetrating through the multi-layered structure or a blind hole formed through at least one layer of the multi-layered structure, such as the upper layer.

The backlit circuit board 10 can further include a light-absorption layer 150. The light-absorption layer 150 is disposed on the switch circuit layer 16 to define at least one light permeable window 152, which corresponds to the keycap 12. The light-absorption layer 150 is preferably made of light-absorbing materials, such as black paint or black ink, and formed on the upper surface of the switch circuit layer 16 by any suitable method, such as printing, to define the at least one light permeable window 152. As shown in FIG. 3, the light-absorption layer 150 can be disposed along the frame rib 117a to form a frame-shaped light permeable window 152, and the light permeable window 152 preferably retreats inside the profile of the corresponding keycap 12 to enhance the uniformity of edge halo of the keycaps 12, but not limited thereto. In an embodiment, the reflective layer 146 and/or the microstructure 144 of the protective layer 140 are preferably located within the vertical projection of the at least one light permeable window 152. When there is a demand for uniform brightness (for example, for the edge halo or character of the keycap 12) or mixing multiple colors, by disposing the reflective surface 146 and/or the microstructure 144 of the protective layer 140 on the bridge ribs (e.g. 117b1, 117b2) and the central island rib 117c that are not covered by the light-absorption layer 150, light scattering/diffusion effects can be provided to facilitate second time reflections and refractions of light between the keycap 12 and the backlit circuit board 10, thereby promoting the lighting effect.

As shown in FIG. 4, when the switch circuit layer 16 is embodied as the membrane switch circuit board, the backlit circuit board 10 can further include a glue layer 170. The glue layer 170 is disposed around the first hole 165 (which serves as the film hole) and adheres the backlit circuit board 10 and the switch circuit layer 16 (which serves as the membrane switch circuit board), and a glue-free region 171 is formed between the glue layer 170 and the first hole 165. Specifically, the glue layer 170 is disposed around the first hole 165 which corresponds to the illuminant 130, so that the switch circuit layer 16 and the illuminant 130 can be positioned by the glue layer 170 to enhance the optical coupling stability. The glue layer 170 is spaced apart from the edge of the first hole 165 of the switch circuit layer 16 to form the glue-free region 171 therebetween, i.e., the region around the first hole 165 without the glue layer 170. Moreover, the switch circuit layer 16 as the membrane switch circuit board preferably has one or more microstructures 168, and the microstructures 168 of the switch circuit layer 16 and/or the microstructures 144 of the protective layer 140 can be disposed in the glue-free region 171, but not limited thereto.

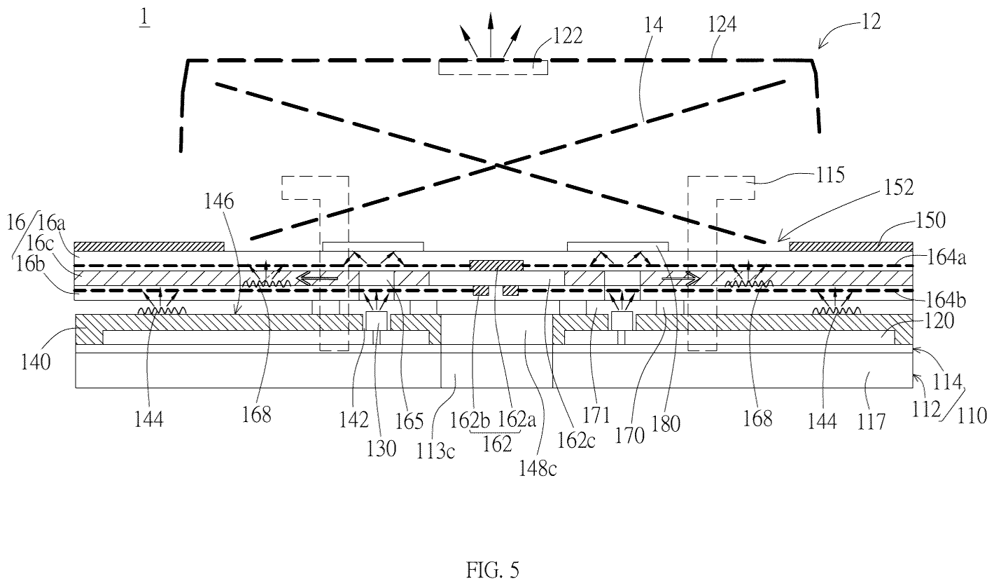

Referring to FIG. 5, FIG. 5 is a schematic cross-sectional view of the backlit keyswitch in another embodiment of the invention. As shown in FIG. 5, the backlit keyswitch 1 of this embodiment can include the keycap 12, a circuit board (such as the backlit circuit board 10), a membrane switch circuit board (such as the switch circuit layer 16), and the glue layer 170. Similar to the previous embodiments, the circuit board has the lighting circuit 120, the illuminant 130, and the plurality of coupling members 115. The plurality of coupling members 115 are configured to directly or indirectly connect the keycap 12. The lighting circuit 120 is disposed on the upper surface of the circuit board and electrically connected to the illuminant 130. The membrane switch circuit board is disposed between the keycap 12 and the circuit board. The membrane switch circuit board has a film hole (such as the first hole 165) for accommodating the illuminant 130. The glue layer 170 is disposed around the film hole and configured to adhere the circuit board (e.g. 10) and the membrane switch circuit board (e.g. 16), and a glue-free region 171 is formed between the glue layer 170 and the film hole. In this embodiment, the details of the keycap 12, the circuit board, the membrane switch circuit board, and the glue layer can be referred to the related descriptions of the keycap 12, the backlit circuit board 10, the switch circuit layer 16, and the glue layer 170 of the previous embodiments. Hereinafter, the differences between this embodiment and the previous embodiments will be focused.

In this embodiment, the membrane switch circuit board can be the switch circuit layer 16 having a multi-layered structure. For example, the switch circuit layer 16 can be a three-layered structure including a first layer 16a, a second layer 16b, and a spacer 16c between the first layer 16a and the second layer 16b, but not limited thereto. In other embodiments, the switch circuit layer 16 can be a multi-layered structure having two or more layers. Each layer of the multi-layered structure can include a light permeable film, such as PET film, but not limited thereto. In this embodiment, the switch circuit 164 includes a first switch wiring 164a disposed on the first layer 16a and a second switch wiring 164b disposed on the second layer 16b. The switch unit 162 includes a first switch pad 162a disposed on the first layer 16a and a second switch pad 162b disposed on the second layer 16b. The first switch wiring 164a is electrically connected to the first switch pad 162a, and the second switch wiring 164b is electrically connected to the second switch pad 162b. The spacer 16c is configured to separate the first switch wiring 164a and the first switch pad 162a on the first layer 16a from the second switch wiring 164b and the second switch pad 162b on the second layer 16b. The spacer 16c has a hole at a location corresponding to where the first switch pad 162a and the second switch pad 162b are disposed. When the keycap 12 moves downward, the triggering portion (such as 182 in the previous embodiment) will be driven to press the first switch pad 162a against the second switch pad 162b, so that the first switch pad 162a and the second switch pad 162b are contacted and conducted to trigger the keyswitch signal.

Moreover, in this embodiment, the first hole 165 of the switch circuit layer 16 serving as the film hole is a blind hole penetrating through at least one layer of the multi-layered structure. For example, the first hole 165 can be a single-layered hole formed in the second layer 16b or a dual-layered hole formed in the second layer 16b and the spacer 16c. With such configurations, light emitted from the illuminant 130 which is accommodated in the film hole can enter the switch circuit layer 16 from the sidewall of the first hole 165, and the switch circuit layer 16 can function as a light guide plate to guide the light in the transverse direction. For example, when the first hole 165 is disposed in the second layer 16b or in the second layer 16b and the spacer 16c, the microstructure 168 of the switch circuit layer 16 is preferably disposed on the lower surface of the second layer 16b or the spacer 16c. In an embodiment, when the switch circuit layer 16 extends over the ribs 117 of the substrate 110 (or the ribs 117a, 117b1, 117b2, 117c in the previous embodiment) to cover the openings (e.g. 113c, 113p), the microstructure 168 of the switch circuit layer 16 can be disposed on the lower surface of the second layer 16b or the spacer 16c and overlap the opening (e.g. 113c, 113p) in the stacking direction.

In this embodiment, the backlit switch 1 further include a reflective layer 180. The reflective layer 180 at least partially covers the illuminant 130. For example, the reflective layer 180 can be disposed on the upper surface of the switch circuit layer 16b (i.e., the upper surface of the first layer 16a) in a form of an island to cover right above the illuminant 130. The reflective layer 180 is preferably made of reflective material (such as white paint or white ink) and formed on the upper surface of the first layer 16a of the switch circuit layer 16 by any suitable methods, such as printing. As such, upward light emitted from the illuminant 130 will be reflected downward from the reflective layer 180 and then reflected upward again from the reflective surface 146 and/or the microstructure 144 of the protective layer 140 to improve the luminance uniformity.

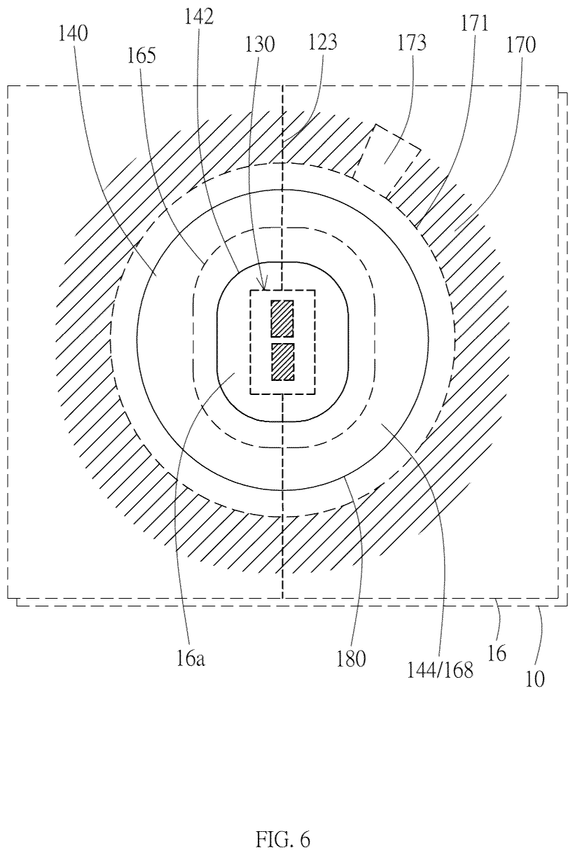

FIG. 6 is a schematic top view showing the upper surface of the backlit circuit board around the illuminant in another embodiment of the invention. As shown in FIG. 6, the glue layer 170 can be an open-ring shaped glue layer with a breach 173, and the breach 173 is configured to provide the air exhaust effect. For example, the breach 173 can be disposed in one or more regions of the glue layer 170. The reflective layer 180 is preferably disposed within the vertical projection of the glue-free region 171, but not limited thereto. According to practical applications, the reflective layer 180 may extend to the glue layer 170.

Although the preferred embodiments of the invention have been described herein, the above description is merely illustrative. The preferred embodiments disclosed will not limit the scope of the invention. Further modification of the invention herein disclosed will occur to those skilled in the respective arts and all such modifications are deemed to be within the scope of the invention as defined by the appended claims.

What is claimed is:

1. A backlit circuit board for supporting a keycap, comprising:
a substrate having a plurality of ribs configured to define a plurality of openings penetrating through the substrate and a plurality of coupling members disposed on the substrate and configured to directly or indirectly connect the keycap;
a lighting circuit disposed on the substrate and located at a same side as the plurality of coupling members, the lighting circuit extending over the plurality of ribs of the substrate; and
an illuminant electrically connected to the lighting circuit and disposed on one of the plurality of ribs of the substrate,
wherein the illuminant vertically corresponds to a light impermeable region of the keycap, and a vertical projection of the light impermeable region at least partially overlaps the plurality of ribs of the substrate.

2. The backlit circuit board of claim 1, wherein the substrate comprises a metal plate and an insulation layer at least partially covering an upper surface of the metal plate.

3. The backlit circuit board of claim 1, further comprising a switch circuit layer, wherein the switch circuit layer and the lighting circuit are disposed at a same side of the substrate;
the switch circuit layer has a switch unit; a vertical projection of the switch unit does not overlap the illuminant.

4. The backlit circuit board of claim 3, wherein the switch circuit layer has a first hole corresponding to the illuminant.

5. The backlit circuit board of claim 4, wherein the switch circuit layer has a second hole corresponding to one of the plurality of coupling members.

6. The backlit circuit board of claim 3, wherein the switch circuit layer has a switch circuit electrically connected to the switch unit; vertical projections of the switch circuit and the lighting circuit at least partially overlaps one of the plurality of ribs.

7. The backlit circuit board of claim 3, wherein the vertical projection of the switch unit and a vertical projection of the illuminant fall within a range surrounded by the plurality of coupling members.

8. The backlit circuit board of claim 3, further comprising a light-absorption layer disposed on the switch circuit layer to define at least one light permeable window corresponding to the keycap.

9. The backlit circuit board of claim 8, further comprising a protective layer disposed on the substrate to cover the lighting circuit; the protective layer has a reflective surface and/or a microstructure located within a vertical projection of the at least one light permeable window.

10. The backlit circuit board of claim 1, wherein the plurality of coupling members extend from the substrate above the lighting circuit.

11. A backlit keyswitch, comprising:
the backlit circuit board of claim 1; and
the keycap.

12. A backlit keyswitch, comprising:
a keycap;
a circuit board having a lighting circuit, an illuminant, and a plurality of coupling members configured to directly or indirectly connect the keycap, the lighting circuit disposed on an upper surface of the circuit board and electrically connected to the illuminant;
a membrane switch circuit board disposed between the keycap and the circuit board, the membrane switch circuit board having a film hole for accommodating the illuminant; and
a glue layer disposed around the film hole and configured to adhere the circuit board and the membrane switch circuit board, wherein a glue-free region is formed between the glue layer and the film hole.

13. The backlit keyswitch of claim 12, wherein the keycap has a light permeable region and a light impermeable region; the illuminant is at least partially located outside of a vertical projection of the light permeable region.

14. The backlit keyswitch of claim 12, wherein the membrane switch circuit board has a switch unit; a vertical projection of the switch unit does not overlap the illuminant.

15. The backlit keyswitch of claim 12, further comprising a reflective layer at least partially covering the illuminant.

16. The backlit keyswitch of claim 12, further comprising a light-absorption layer disposed on the membrane switch circuit board to define at least one light permeable window corresponding to the keycap.

17. The backlit keyswitch of claim 16, wherein the circuit board further has a protective layer configured to cover the lighting circuit; the protective layer has a reflective surface and/or a microstructure located within a vertical projection of the at least one light permeable window.

18. The backlit keyswitch of claim 12, wherein the membrane switch circuit board is a multi-layered structure; the film hole is a through hole penetrating through the multi-layered structure or a blind hole formed though at least one layer of the multi-layered structure.

19. The backlit keyswitch of claim 18, wherein the membrane switch circuit board has a microstructure; when the film hole is the blind hole formed though the at least one layer of the multi-layered structure, the microstructure is disposed on the at least one layer of the multi-layered structure.

20. The backlit keyswitch of claim 12, wherein the glue layer is an open-ring shaped glue layer with a breach.
